(19) United States
(12) Patent Application Publication
(10) Pub. No.: US 2013/0037634 A1
(43) Pub. Date: Feb. 14, 2013

(54) MICRONOZZLE ATOMIZERS AND METHODS OF MANUFACTURE AND USE

(71) Applicants: Richard T. Miller, Corvallis, OR (US); Neill Thornton, Corvallis, OR (US)

(72) Inventors: Richard T. Miller, Corvallis, OR (US); Neill Thornton, Corvallis, OR (US)

(21) Appl. No.: 13/640,038

(22) PCT Filed: Apr. 8, 2011
(86) PCT No.: PCT/US11/31732

§ 371 Date: Oct. 8, 2012

Related U.S. Application Data
(60) Provisional application No. 61/322,220, filed on Apr. 8, 2010.

(51) Int. Cl. B05B 1/00

(52) U.S. Cl. 239/589

(57) ABSTRACT

A micronozzle device can include at least two layers stacked together to form a nozzle array. Each layer can include a plurality of microchannels that have inlet ports and exit ports. The exit ports can be oriented substantially perpendicular, parallel, or in the general direction of a central fluid flow pathway.

### CROSS-REFERENCE TO RELATED APPLICATIONS

This application claims the benefit of U.S. Patent Application No. 61/322,220, filed Apr. 8, 2010. The entire disclosure of U.S. Patent Application No. 61/322,220 is hereby incorporated herein by reference.

### FIELD

This disclosure relates generally to micronozzle atomizers, and applications and methods of making and using micronozzle atomizers.

### BACKGROUND

Micro-fluid processing is a rapidly evolving area in research and industry. The need for control over biochemical and chemical reactions is useful for reducing reagent waste and minimizing sample sizes. Various nozzles have been developed to atomize fluids and direct the atomized fluids towards a sample area. However, such conventional nozzles have several drawbacks, including material incompatibility, size restrictions, low nozzle densities, and high costs associated with the manufacture and/or use of the nozzles.

### SUMMARY

This disclosure describes micronozzle devices designed for aerosol generation and constructed using laminated architectures. The devices can have dense arrays of micronozzles, enabling high throughput of small droplets. The short nozzle length can have a low pressure drop allowing low pressure delivery techniques to be used to eject droplets, including, but not limited to, pulsing using piezo, thermal inkjet, electrostatic, and acoustic drivers. Constant pressure sources can be used for ejection depending on the application needs. Additionally, if desired, a pressure pulse can be superimposed upon a constant pressure source. Precise dimensional control of nozzles can result in tight droplet size distributions. The formation of these controlled distributions of small droplets can have great utility in a broad number of applications, including, but not limited to, fuel injection, spray drying (especially pharmaceutical production), flash evaporation and distillation, evaporation of fuel entering a combustor, and pulmonary drug delivery.

In one embodiment, a micronozzle device is provided with at least two layers stacked together to form a nozzle array. One or more of the layers includes a plurality of microchannels that have at least one inlet port and a plurality of exit ports, with the exit ports being adjacent to a central fluid flow pathway. The central fluid flow pathway is defined by an annulus of the nozzle array, and the exit ports of the nozzle array face the central fluid flow pathway. Alternating layers of fuel plates and air plates can be provided, with the fuel plates including at least one fuel header channel configured to deliver a fuel to a plurality of vias in the air plate and the air plate including at least one air header channel to deliver air to be mixed with the fuel entering the vias of the air plate to form a mixture of air and fuel.

In one embodiment, a micronozzle device comprises at least two layers stacked together to form a nozzle array. Each layer can include a plurality of microchannels that have an inlet port and an exit port. The exit port can be oriented substantially perpendicular to a central fluid flow pathway.

In specific implementations, the central fluid flow pathway can be defined by an annulus of the nozzle array, and the exit ports of the nozzle array can face the central fluid flow pathway. The annulus of the nozzle array can form an outer perimeter of the central fluid flow pathway. At least one header channel can be configured to provide fluid to the inlet ports of the plurality of microchannels. Each layer can have a first side and a second side, and microchannels can be formed on both the first and second sides. Microchannels on adjacent layers can be in a staggered arrangement so that microchannels on facing surfaces of adjacent layers do not overlap one another. The length of each microchannel can be less than about 250 μm or less than about 125 μm. The width of each microchannel can be greater than about 50 μm.

In other specific implementations, the nozzle array can be positioned within the central fluid flow pathway, and the exit ports of the nozzle array can face the central fluid flow pathway. The exit ports can substantially surround the perimeter of the nozzle array. At least one header channel can be configured to provide fluid to the inlet ports of the plurality of microchannels. Each layer can have a first side and a second side, and microchannels can be formed on both the first and second sides. Microchannels on adjacent layers can be in a staggered arrangement so that microchannels on facing surfaces of adjacent layers do not overlap one another. The length of each microchannel can be less than about 250 μm or less than about 125 μm. The width of each microchannel can be greater than about 50 μm. The nozzle array can include a porous member at an end of the nozzle array. A housing can be provided that has an inner surface that defines the central fluid flow pathway, and at least a portion of the inner surface can be covered by a screen member.

In another embodiment, a micronozzle device can include plurality of nozzle arrays spaced apart from one another to form a secondary pathway therebetween. Each nozzle array can have a plurality of microchannels that have an inlet port and an exit port. The exit port can be oriented substantially parallel to a central fluid flow pathway such that fluid flowing in the central fluid flow pathway can enter the secondary pathways and pass between the plurality of nozzle arrays. Each nozzle array can include a plurality of layers laminated together to form a single structure. At least one header channel can be configured to provide fluid to the inlet ports of the plurality of microchannels. Each layer can have a first side and a second side, and microchannels can be formed on both the first and second sides. Microchannels on adjacent layers can be in a staggered arrangement so that microchannels on facing surfaces of adjacent layers do not overlap one another. The length of each microchannel can be less than about 250 μm or less than about 125 μm. The width of each microchannel can be greater than about 50 μm.

In other specific implementations, a micronozzle device is provided. The device comprises an air plate having an air inlet, an air header microchannel, a plurality of exit ports, and a plurality of vias. The air plate is configured to receive air through the air inlet and deliver the air through the air header microchannel to the plurality of exit ports. The device further comprises a fuel plate having a fuel inlet and a fuel header microchannel. The fuel plate is configured to receive fuel through the fuel inlet and deliver the fuel to the air plate through the plurality of vias formed in the air plate. The air and fuel plates are stacked together to form a nozzle array and the exit ports are oriented substantially perpendicular to a central fluid flow pathway.

In some embodiments, the air plate further comprises metering nozzles positioned between the vias and the exit ports, the metering nozzles being configured to control the flow of fuel delivered to the exit ports. The nozzle array can include a plurality of air plates and a plurality of fuel plates that are stacked together in an alternating arrangement. The central fluid flow pathway can be defined by an annulus of the nozzle array, and the exit ports can be configured to face the central fluid flow pathway. The annulus of the nozzle array can form an outer perimeter of the central fluid flow pathway.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates an embodiment of a micronozzle device with a laminated architecture that has an annular structure, wherein atomized fluid can be directed perpendicularly into a center fluid channel or flow stream.

FIG. 2 is an enlarged top view of an embodiment of a nozzle plate (layer) shown in FIG. 1.

FIG. 3 is an enlarged perspective view of an embodiment of a nozzle plate (layer) shown in FIG. 1, showing microchannels on both sides of the plate.

FIG. 4 is a side perspective view of an embodiment of a micronozzle device with a plurality of nozzle plates (layers).

FIG. 5 is a perspective view of an embodiment of a nozzle plate configured for a 9 mm air intake bore.

FIG. 6 illustrates an enlarged view of the nozzle plate of FIG. 5 constructed out of Viton®.

FIG. 7 illustrates a further enlarged view of a plurality of microchannels of the nozzle plate of FIG. 5.

FIG. 8 illustrates an enlarged view of a plurality of microchannels of the nozzle plate of FIG. 5, which are laser cut in stainless steel.

FIG. 9 illustrates an enlarged view of a plurality of microchannels of the nozzle plate of FIG. 5, which are laser cut in polyetherimide.

FIG. 10 is a table depicting the relationship between microchannel size and exit velocities and related parameters.

FIGS. 11A and 11B show modeling results of two different length microchannel configurations.

FIGS. 12A and 12B illustrate nozzles embossed in polycarbonate from photolithographic masters.

FIGS. 13A and 13B illustrate nozzles laser machined in polyetherimide.

FIG. 13A illustrates a top view and FIG. 13B illustrates an end view.

FIG. 14 is another table depicting the relationship between microchannel size and exit velocities and related parameters.

FIG. 15 illustrates vertical through-cut nozzles fed from ports in communication with header plates.

FIG. 16 illustrates horizontal through-cut nozzles fed from ports in communication with header plates.

FIG. 17 illustrates an embodiment of a center feed configuration in which bulk fluid flows in an annulus at least partially surrounding the nozzle (injector).

FIG. 18 illustrates another embodiment of a center feed configuration with a plurality of nozzle channels extending outwards to the perimeter of a nozzle (injector).

FIG. 19 shows an enlarged view of a nozzle shim of the type shown in FIG. 18.

FIG. 20 shows an enlarged view of a connector shim of the type shown in FIG. 18.

FIG. 21 illustrates an embodiment of a collinear flow configuration with a plurality of nozzles oriented in the same direction as bulk fluid flow.

FIG. 22 illustrates an exploded view of a subunit shown in FIG. 21.

FIG. 23 is an image of discrete 300 μm diameter droplets ejected from a nozzle driven by a piezo pump operating at 300 Hz.

FIG. 24 illustrates a fuel plate with an fuel inlet, a fuel header, and an air inlet to the atomizer.

FIG. 25 illustrates an air plate through which fuel can flow through the vias to the metering nozzle where the fuel is mixed with an air stream and ejected out the exit nozzle.

FIG. 26 is a microscopic image of a portion of the air plate shown in FIG. 25.

FIG. 27 illustrates a stacked configuration of fuel plates (FIG. 24) and air plates (FIG. 25).

FIG. 28 illustrates another embodiment of an air plate.

FIG. 29 illustrates another embodiment of a fuel plate.

FIG. 30 is a microscopic image of a portion of the air plate shown in FIG. 28.

FIG. 31 illustrates another embodiment of an air plate.

FIG. 32 illustrates another embodiment of a fuel plate.

FIG. 33 is a microscopic image of a portion of the air plate shown in FIG. 31.

FIG. 34 illustrates an embodiment of a device with a nozzle for mixing air and fuel and an exit for ejecting the air/fuel mixture.

FIG. 35 illustrates another embodiment of a device with a nozzle and an exit to eject an air/fuel mixture.

FIG. 36 illustrates another embodiment of a device with a nozzle and an exit to eject an air/fuel mixture.

FIG. 37 illustrates another embodiment of a device with a nozzle and an exit to eject an air/fuel mixture.

FIG. 38 illustrates another embodiment of a device with a nozzle and an exit to eject an air/fuel mixture.

FIG. 39 illustrates another embodiment of a device with a nozzle and an exit to eject an air/fuel mixture.

FIG. 40A illustrates an embodiment of a device with an array of nozzles and exits to eject an air/fuel mixture.

FIG. 40B is a close up view of one of the nozzles and exits of FIG. 40.

FIG. 41A illustrates another embodiment of a device with an array of nozzles and exits to eject an air/fuel mixture.

FIG. 41B is a close up view of one of the nozzles and exits of FIG. 40.

FIG. 42 is a graph comparing ejected droplet size of various embodiments of nozzles and exits.

FIG. 43 is another graph comparing ejected droplet size of various embodiments of nozzles and exits.

FIG. 44 is another graph comparing ejected droplet size of various embodiments of nozzles and exits.

FIG. 45 is another graph comparing ejected droplet size of various embodiments of nozzles and exits, at various pressures.

FIG. 46 is another graph comparing ejected droplet size of various embodiments of nozzles and exits, at various pressures.

FIG. 47 is another graph comparing ejected droplet size of various embodiments of nozzles and exits, at various pressures.

FIG. 48 is another graph comparing ejected droplet size of various embodiments of nozzles and exits, at various pressures.

FIG. 49A illustrates a stack of four nozzle plates.

FIG. 49B illustrates an enlarged view of the nozzles and exit channels of the device of FIG. 49A.

FIG. 50 illustrates a chart showing the engine speed and throttle position of a system utilizing a stack of nozzle plates as shown in FIG. 49A to provide an air/fuel mixture to an engine.

FIG. 51 illustrate a chart showing the engine speed and temperature of a system utilizing a stack of nozzle plates as shown in FIG. 49A to provide an air/fuel mixture to an engine.

FIG. 52 illustrates an array of micronozzles that can be used for atomization as part of a desalination process.

FIG. 53 illustrates system that utilizes a plurality of the micronozzle arrays shown in FIG. 52.

FIG. 54 illustrates another view of a system that utilizes a plurality of the micronozzle arrays shown in FIG. 52.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and subcombinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” and “achieve” to describe the disclosed methods. These terms are high-level abstractions of the actual operations that are performed. The actual operations that correspond to these terms may vary depending on the particular implementation and are readily discernible by one of ordinary skill in the art.

The embodiments described herein include micronozzle devices constructed using layers of patterned sheets to form laminated architectures. The materials can include polymers, metals, or, in some cases, ceramics. The layers can be bonded to create leak-free self contained structures. Bonding techniques can include, but are not limited to, diffusion bonding, diffusion brazing, welding, adhesively bonding, ultrasonically bonding, microwave welding, and infrared welding.

There are applications, however, where it may be desirable to disassemble the construction; in these cases a fixture holding the layers under compression can be used. Alternately, adhesives than can be dissolved or otherwise removed to allow disassembly and rework may be used.

As described in more detail below, the nozzle arrays can be provided in various configurations and orientations, including annular, center feed, and collinear-flow configurations.

Annular Configurations

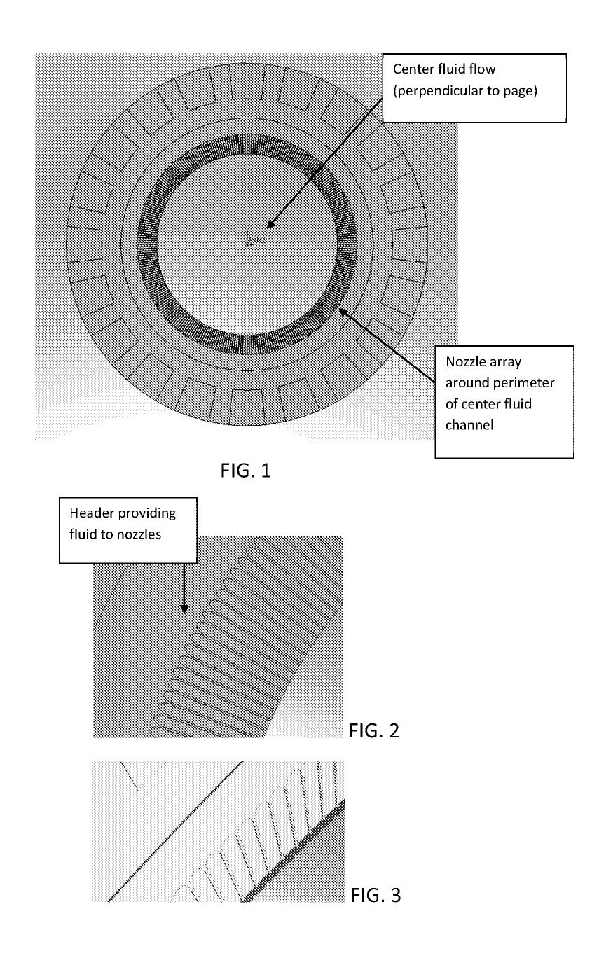

FIG. 1 illustrates an embodiment of a micronozzle device with a laminated architecture that has an annular structure. A plurality of nozzle microchannels can be positioned so that they at least partially surround the outer perimeter of the center pathway or channel through which bulk fluid can flow. Thus, atomized fluid can be directed perpendicularly out of each microchannel into the flow stream of fluid in the center channel.

FIG. 2 is an enlarged top view of an embodiment of a nozzle plate or layer of the laminated micronozzle device shown in FIG. 1. As shown in FIG. 2, a header can provide fluid to the plurality of microchannels. The nozzle plate or layer can include microchannel structures on both sides of the plate as shown in FIG. 3.

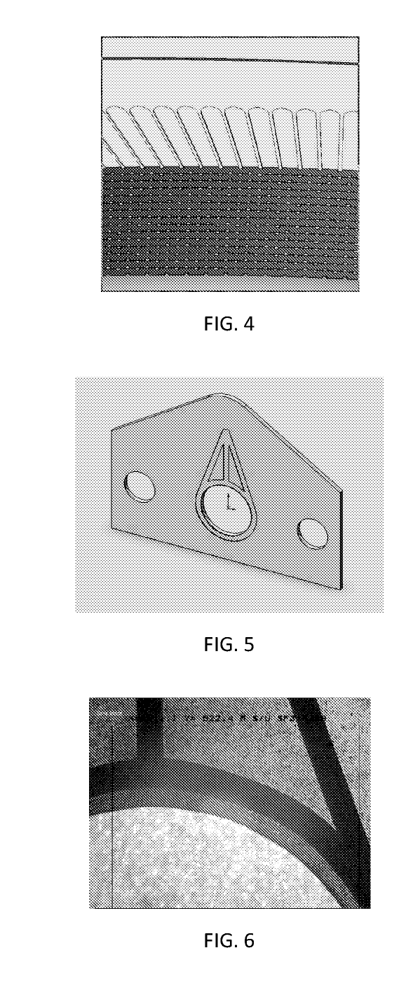

FIG. 4 is a side perspective view of an embodiment of a micronozzle device with a plurality of nozzle plates or layers. Each of these plates can include microchannel structures on both sides (FIG. 3). In addition, as shown in FIG. 4, microchannels on adjacent plates can be in a staggered arrangement so that microchannels on adjacent plate surfaces do not overlap one another.

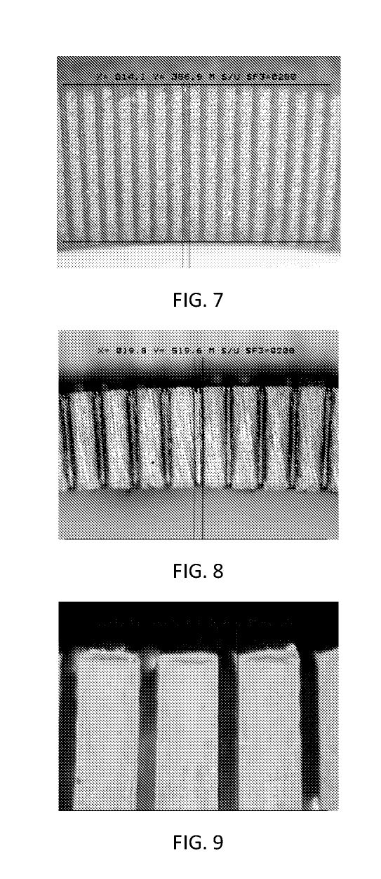

FIG. 5 is a perspective view of an embodiment of a nozzle plate configured for a 9 mm air intake bore. As shown in FIGS. 6-9 and as discussed above, an annular laminated architecture nozzle device can be constructed of various materials. For example, FIGS. 6 and 7 are enlarged views of a nozzle plate constructed out of Viton®, FIG. 8 is an enlarged view of a plurality of microchannels that are laser cut in stainless steel, and FIG. 9 is an enlarged view of a plurality of microchannels that are laser cut in polyetherimide.

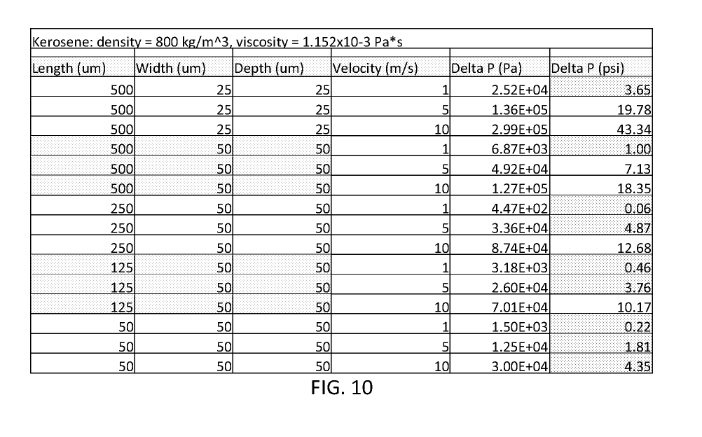

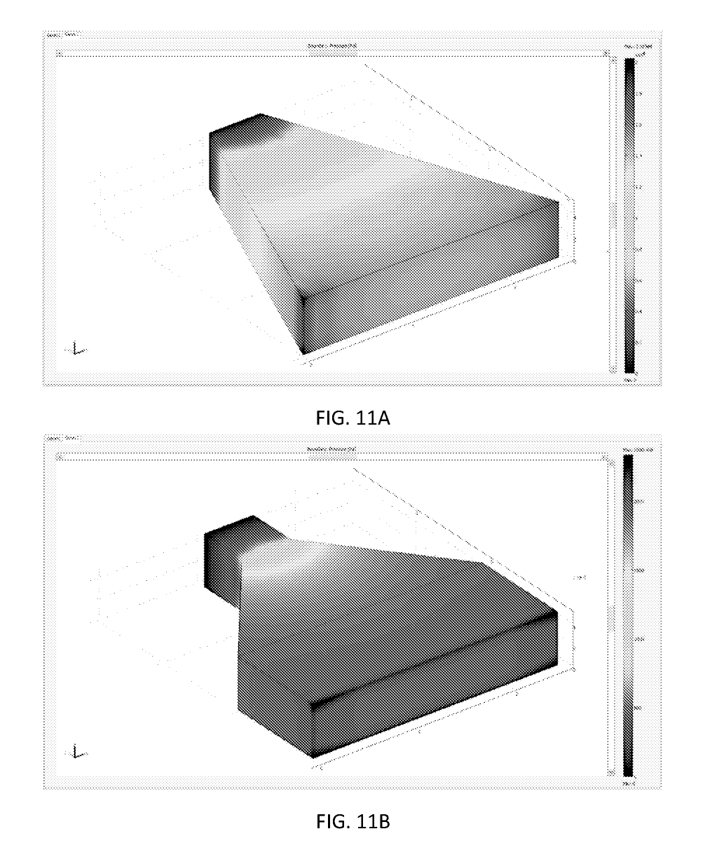

In certain embodiments, it can be desirable to achieve a certain pressure drop through the nozzle. For example, a pressure drop that is acceptable for inkjet-type dispensing preferably exhibits an exit velocity of between about 5-10 m/s and a psi of less than about 10. As shown in FIGS. 10, 11A, and 11B, shorter nozzles can be preferable to achieve a lower psi. For example, FIG. 10 shows a table depicting the relationship between microchannel size and exit velocities and related parameters. As shown in FIG. 10, nozzles less than 250 μm and, more preferably less than about 125 μm, and, even more preferably, less than about 100 μm (e.g., about 50 μm) can be particularly desirable for such applications. FIGS. 11A and 11B show modeling results of two different length microchannel configurations, which also reveals that advantages can be achieved by using nozzles with shorter lengths.

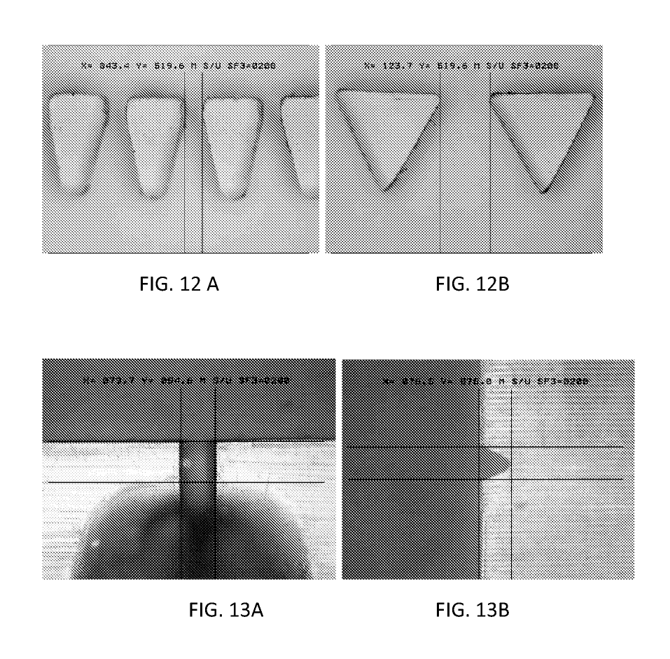

As discussed above various methods can be used to create the microchannel structures disclosed herein. Desirably, however, appropriate nozzle bores and lengths can be achieved using photolithographic methods and/or laser machining. FIGS. 12A and 12B illustrate nozzles that were created using hot embossing from a photolithographic master. FIGS. 13A and 13B illustrate shorter nozzles that were laser machined in polyetherimide. FIG. 13A illustrates a top view and FIG. 13B illustrates an end view.

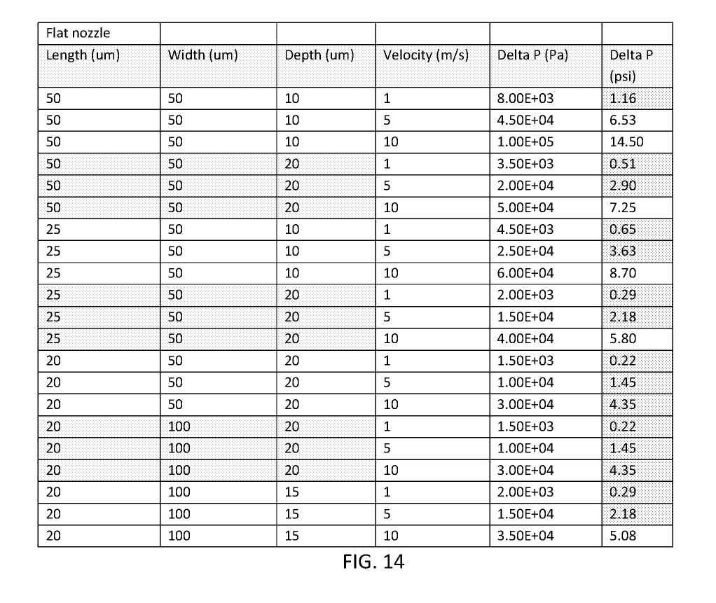

As noted above, shorter nozzles with lower pressure drops can have certain advantages with respect to small droplet formation. As reflected in FIG. 14, in another embodiment, wide, shallow nozzles can be used to further improve small droplet formation. As reflected in the table shown in FIG. 14, the pressure drop can be substantially independent of width at the aspect ratios of interest, which can enable high fluid (e.g., fuel) throughput per nozzle.

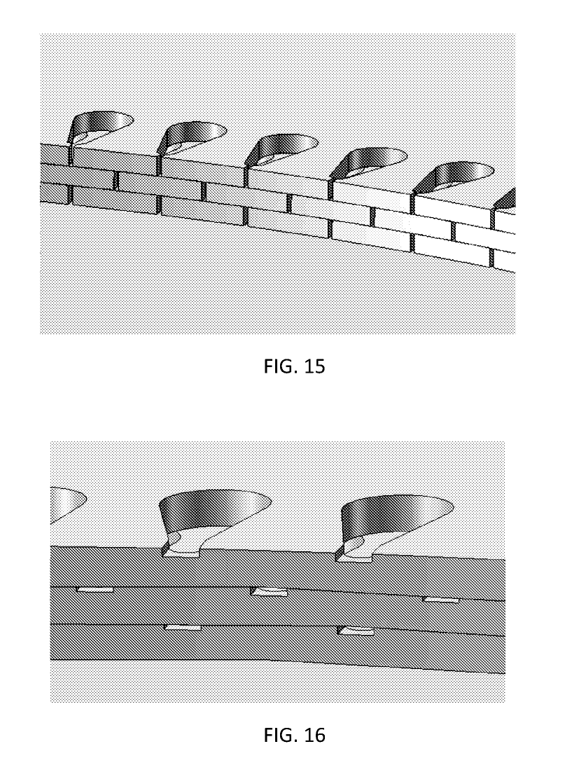

FIGS. 15 and 16 illustrate various wide, shallow nozzles that can be constructed using, for example, laser machining or embossing techniques. FIG. 15 illustrates vertical through-cut nozzles fed from ports in communication with header plates. FIG. 16 illustrates horizontal through-cut nozzles fed from ports in communication with header plates. To the extent that fluid collection around the nozzle exit (e.g., “puddling”) affects droplet ejection, features such as gutters and protruding nozzle exits can be implemented to alleviate such problems.

Center Feed Configurations

In this embodiment, a nozzle device can be positioned within a flow stream or pathway and fluid can be jetted perpendicularly outwards from the nozzle device into the bulk fluid stream.

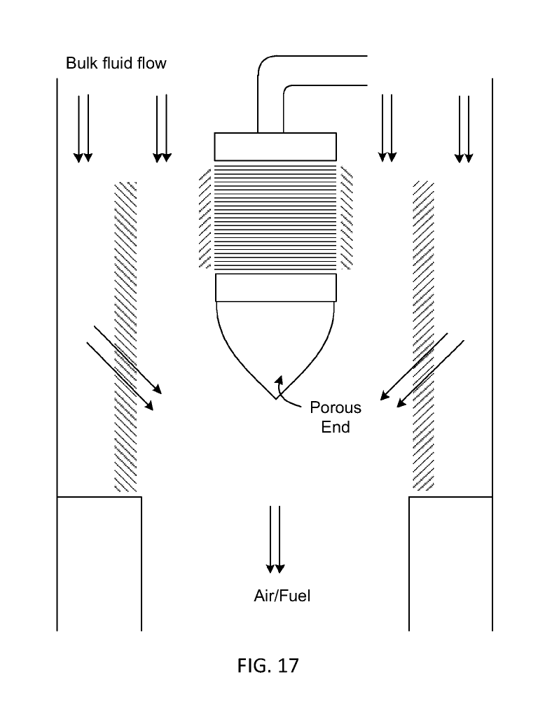

FIG. 17 illustrates an embodiment of a center feed configuration in which bulk fluid flows in an annulus at least partially surrounding the nozzle (injector). The bulk fluid can flow in a pathway or annulus around the injector. This configuration can result in a simpler bonding arrangement, which can result in fewer leak paths. FIG. 17 illustrates a design configuration that can be used, for example, as a fuel injector or other similar devices. A porous end piece can capture droplets produced by nozzle surface wetting, and a screen can be provided along the wall to reduce wetting of the outer wall. These structures can provide large surface areas to enhance evaporation of the wetting fluid. For applications that involve fuel injection and fuel evaporation, it can be particularly helpful to prevent large droplet transport into the reaction or combustion chambers.

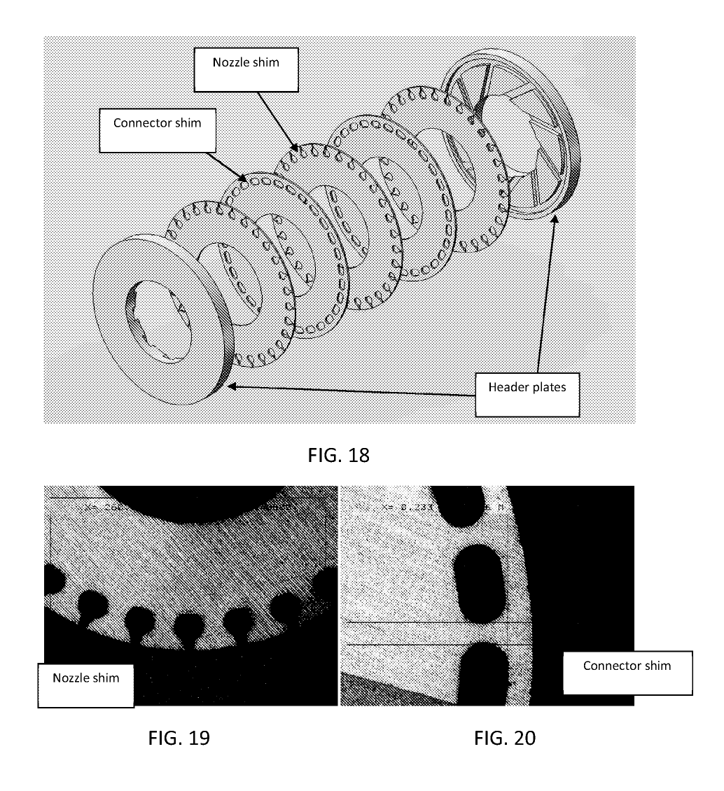

FIG. 18 illustrates another embodiment of a center feed configuration with a plurality of nozzle channels extending outwards to the perimeter of a nozzle (injector). The structure of FIG. 18 can include a pair of header plates and a plurality of connector shims and nozzle shims. FIG. 19 shows an enlarged view of a nozzle shim, and FIG. 20 shows an enlarged view of a connector shim.

Collinear Configurations

In this embodiment, fuel (or other fluids) can be jetted through nozzles that are oriented in the same direction as the air flow. By providing a plurality of nozzles that are spaced apart, air can flow between layers of nozzle plates. Although the nozzle density of this embodiment can be less than the other embodiments described herein, this configuration can be helpful to reduce wall wetting, particularly in small devices. The spacing between the nozzle plates can be a function of the allowable pressure drop of the air though the device.

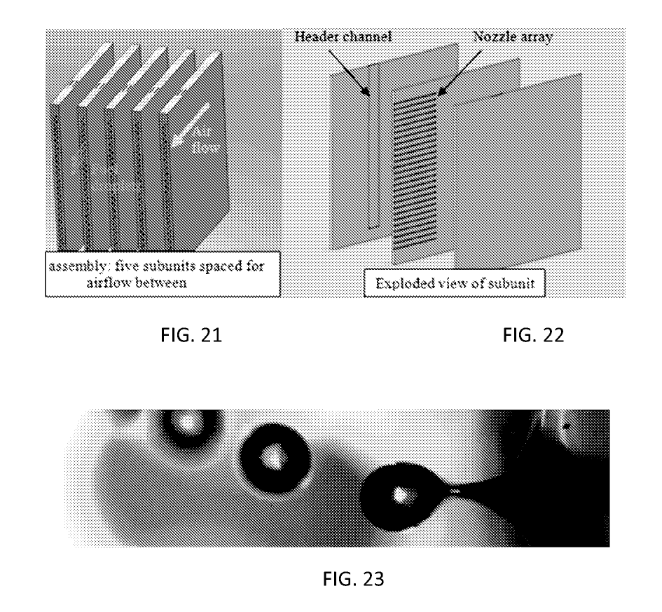

FIG. 21 illustrates an embodiment of a collinear flow configuration with a plurality of nozzles oriented in the same direction as bulk fluid flow. The nozzle subunits in FIG. 21 are shown spaced apart from one another to permit fluid flow between adjacent subunits. FIG. 22 illustrates an exploded view of a subunit, which can include at least one header channel and at least one nozzle array. Desirably, a header channel can be positioned on each side of the nozzle array.

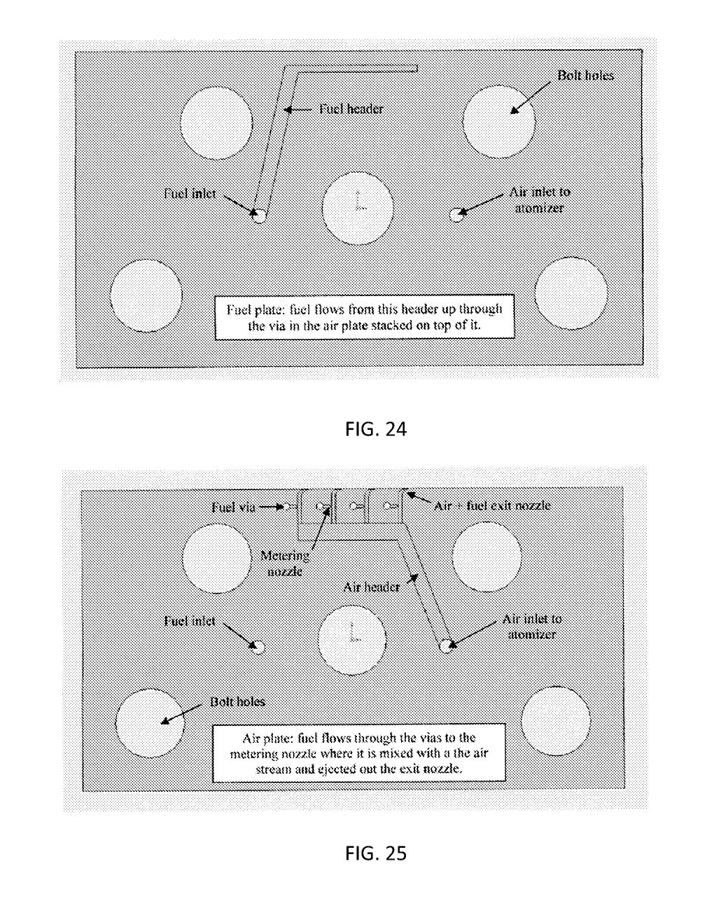

The following embodiments of airblast atomizers can advantageously impart lateral kinetic energy to an air/fuel mixture by inducing breakup of the fuel into even smaller droplets. FIG. 24 illustrates a fuel plate that is configured to allow fuel to flow from a header (up through a via) into an air plate that is stacked on top of the fuel plate. FIG. 24 illustrates a fuel inlet, a fuel header, and an air inlet to the atomizer. FIG. 25 illustrates a respective air plate through which fuel can flow through the vias to the metering nozzle where the fuel is mixed with an air stream and ejected out the exit nozzle.

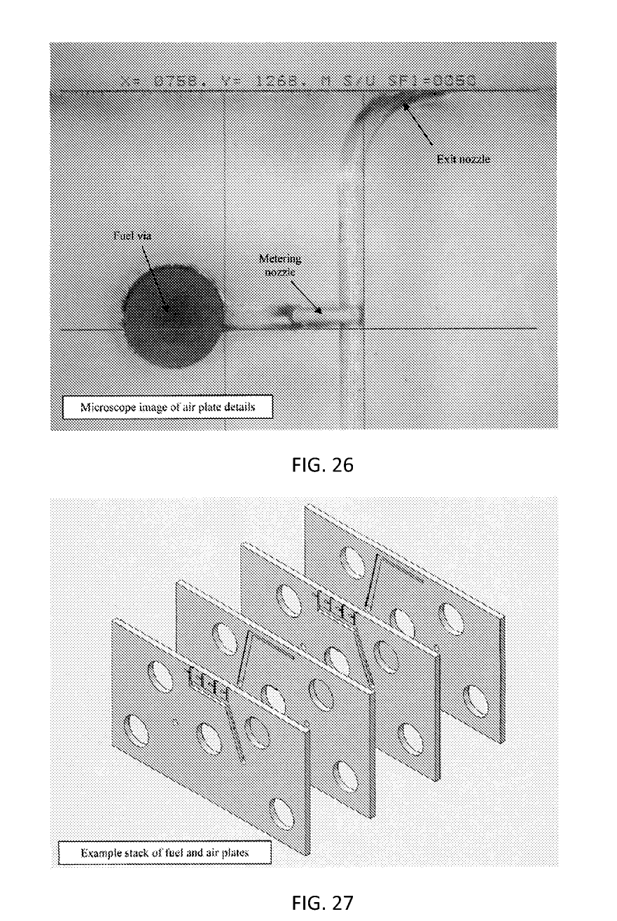

FIG. 26 is a microscopic image of a portion of the air plate shown in FIG. 25. Referring to FIG. 26, fuel enters through the fuel via (which is fed from the fuel header shown in FIG. 24) and delivered through the metering nozzle where it is mixed with air from the air header (FIG. 25). FIG. 27 illustrates a stacked configuration of fuel plates (FIG. 24) and air plates (FIG. 25). As shown in FIG. 27, fuel and air plates can be in an alternating stacked architecture.

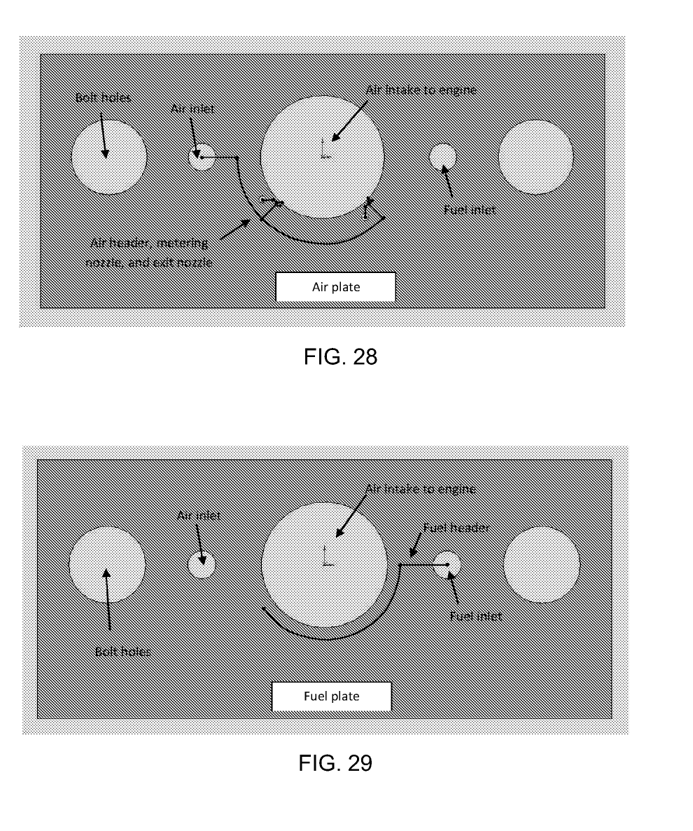

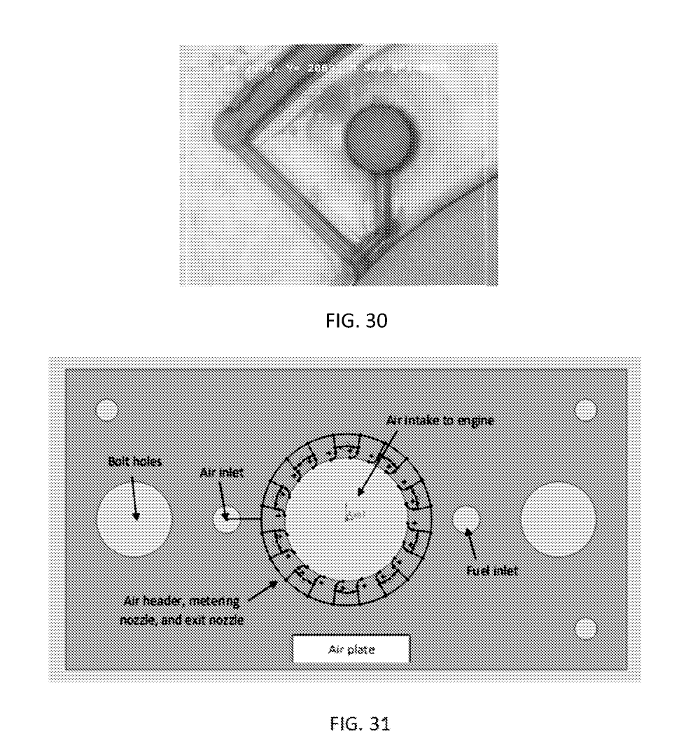

FIGS. 28-30 illustrate another embodiment of an airblast nozzle. In this embodiment, an annular configuration is provided with the air and fuel mixture being introduced to a central air intake unit to deliver the air/fuel mixture to an engine (e.g., a two-cycle engine). As shown in FIGS. 28 and 29, air and fuel can be delivered through air and fuel headers, respectively, to be mixed and delivered through one or more exit nozzles to the central air intake passage. FIG. 30 illustrates a microscopic image of a portion of the air plate shown in FIG. 28. As shown in FIG. 30, fuel is delivered from the fuel plate (FIG. 29) through a via, then through a metering nozzle to be mixed with air arriving from the air header.

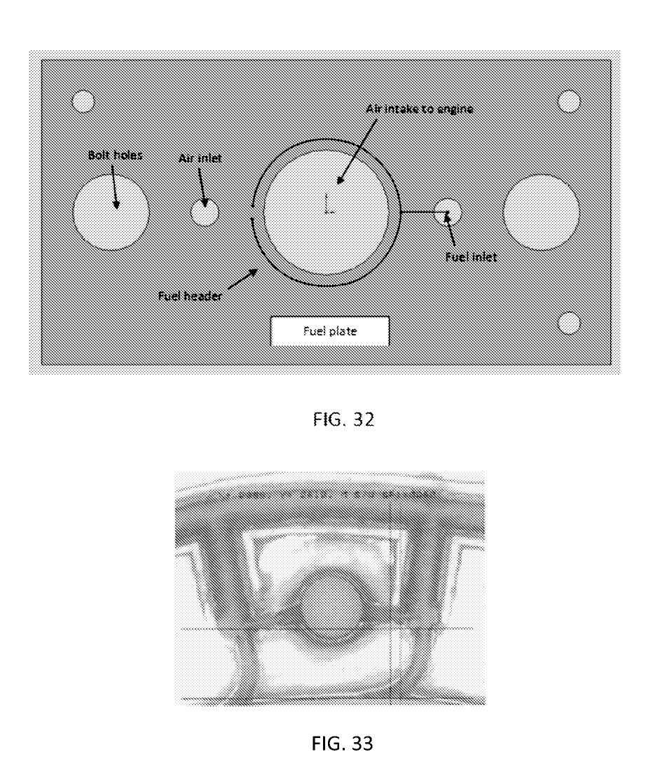

FIGS. 31-33 show an embodiment similar to that shown in FIGS. 28-30, but with additional exit nozzles to provide increased delivery of air/fuel mixture at lower pressures. For example, the air plate shown in FIG. 31 and the fuel plate shown in FIG. 32 can be provided in a stacked configuration with a desired number of air and fuel plates. As shown in FIGS. 31 and 32, air and fuel can be delivered through air and fuel headers, respectively, to be mixed and delivered through the exit nozzles provided in the vicinity of the central air intake passage. FIG. 33 illustrates a microscopic image of a portion of the air plate shown in FIG. 30. As shown in FIG. 33, fuel is delivered from the fuel plate (FIG. 32) through one or more vias, then through one or more metering nozzles to be mixed with air arriving from the air header.

### EXAMPLES

Different embodiments of devices were tested. The attributes of each of the embodiments of the devices tested are shown below in Table 1. The width measurements were made using a magnification of 200×, which is greater than the magnification of the images shown herein.

TABLE 1

| | Nozzle W | | | |
|---|---|---|---|---|
| Nozzle design | (micron) | Exit W (micron) | Shape | Exit orientation |
| single nozzles | | | | |
| Ex. 1 (AB4H) | 83 | 156 | curved | perpendicular |
| Ex. 2 (AB4D) | 59 | 83 | curved | perpendicular |
| Ex. 3 (AB4C) | 48 | 118 | curved | perpendicular |
| Ex. 4 (AB3-3) | 91 | 153 | curved | tangent |
| Ex. 5 (AB5D2) | 68 | 158 | curved | perpendicular |
| Ex. 6 (AB5C) | 48 | 137 | straight | perpendicular |
| nozzle arrays | | | | |
| Ex. 7 (AB3L) | 87 | 171 | curved | tangent |
| Ex. 8 (AB4L) | 63 | 96 | curved | perpendicular |

The testing was performed using a phase doppler particle analyzer (manufactured by TSI, Inc, St. Paul, Minn.). The analyzer was used to measure droplet sizes during spray drying operations which typically use acetone as a delivery solvent. The laser and detector of the analyzer were therefore mounted to view into a spray drying vessel where the solvent could be safely contained. The test devices were mounted on the end of a rod, with air and fuel lines fed up through it, connecting to the supplies. House nitrogen was used as the gas supply and also provided pressure for fuel delivery. Standard kerosene was used as the fuel. The rod is mounted on a linear drive to allow measurements of particle sizes across the width of the plume (the laser beam is stationary, the plume from the device is moved through the beam).

The detector captures data from interference fringes generated from droplets at the point where the two laser beams (split from one) intersect. As such, the precise point where data is collected can be controlled. For the most of our measurements this distance was approximately 0.5 inches. A schematic of the setup is shown below.

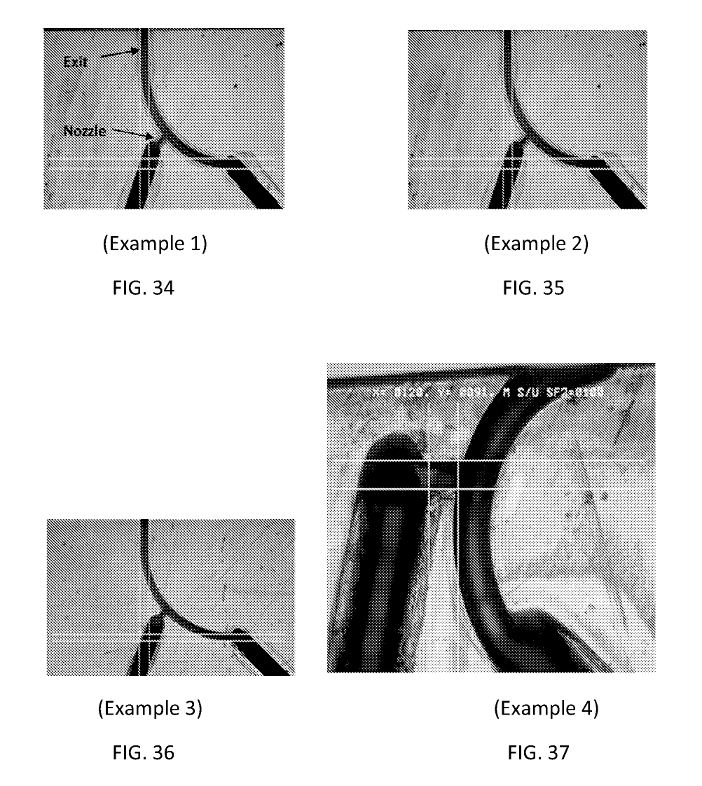

Images of portions of the devices tested in Examples 1-3 are shown in FIGS. 34-36, respectively. In some of the disclosed embodiments, lateral energy is induced through a curved exit channel. For example, FIGS. 34-36 illustrate curved exit channels that are oriented so that the droplets are ejected generally perpendicularly to the edge of the plate. The nozzle and exit widths of these embodiments vary as shown above in Table 1.

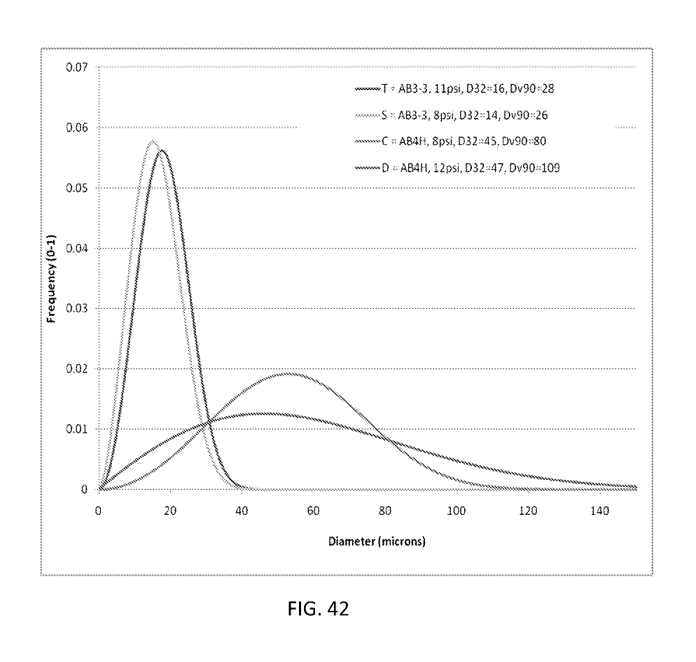

An image of the device of Example 4 is shown in FIG. 37. Example 4 also illustrates a curved exit channel; however, Example 4 differs from Examples 1-3 in that the exit channel is oriented to be generally tangential to the plate edge. As shown in the graph shown in FIG. 42, a tangential exit can be beneficial. See, for example, a comparison on the curve of Example 1 (AB4H) with Example 4 (AB3-3), which have similar nozzle and exit dimensions.

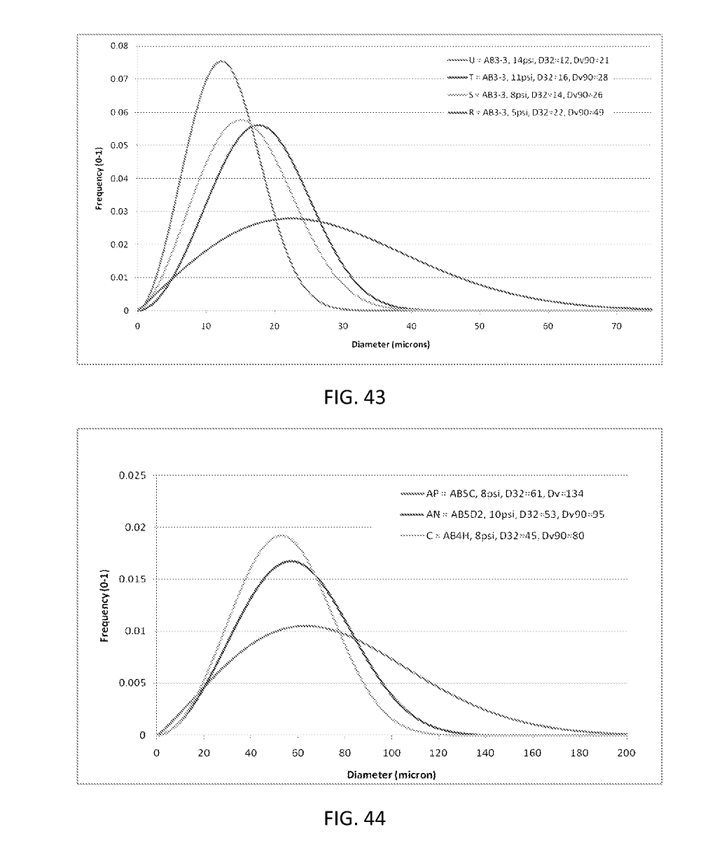

FIG. 43 is another graph of the device of Example 4, taken over a range of pressures (e.g., 5 psi, 8 psi, 11 psi, and 14 psi). As seen in FIG. 43, droplet size decreases significantly above a pressure of 5 psi.

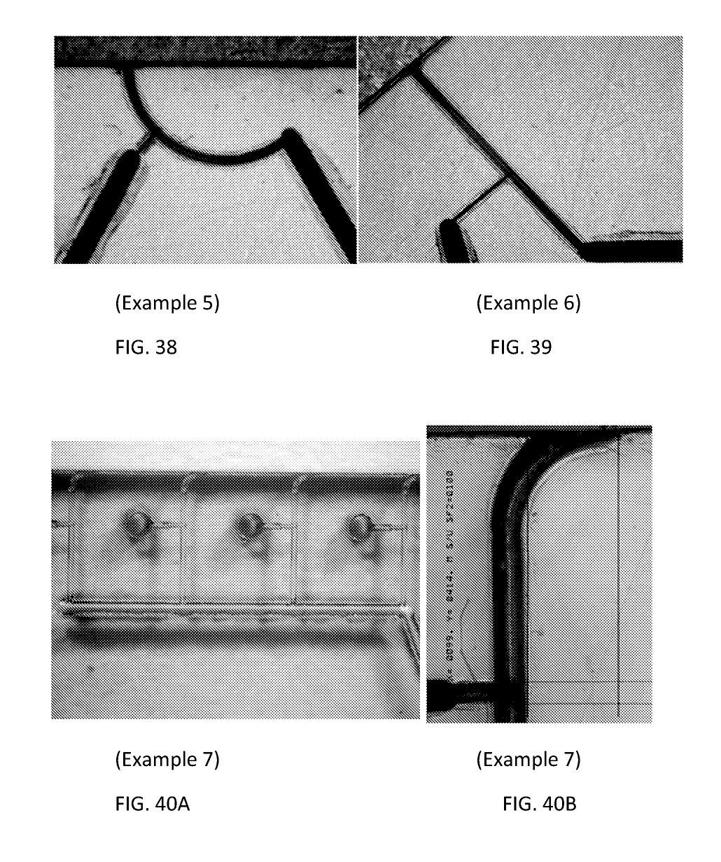

FIGS. 38 and 39 illustrate images of the devices of Examples 5 and 6, respectively. FIG. 44 is a graph showing the results of Examples 5 and 6 compared to those of Example 1.

As shown in Table 1 above, two different nozzle arrays were tested. For the purposes of this test, both were constructed with 4 nozzles per plate. However, as discussed elsewhere herein, the number of nozzles can vary depending on the application. FIG. 40A illustrates an image of the nozzle array of Example 7, and FIG. 40B shows an enlarged view of a portion of one of the exit channels of Example 7.

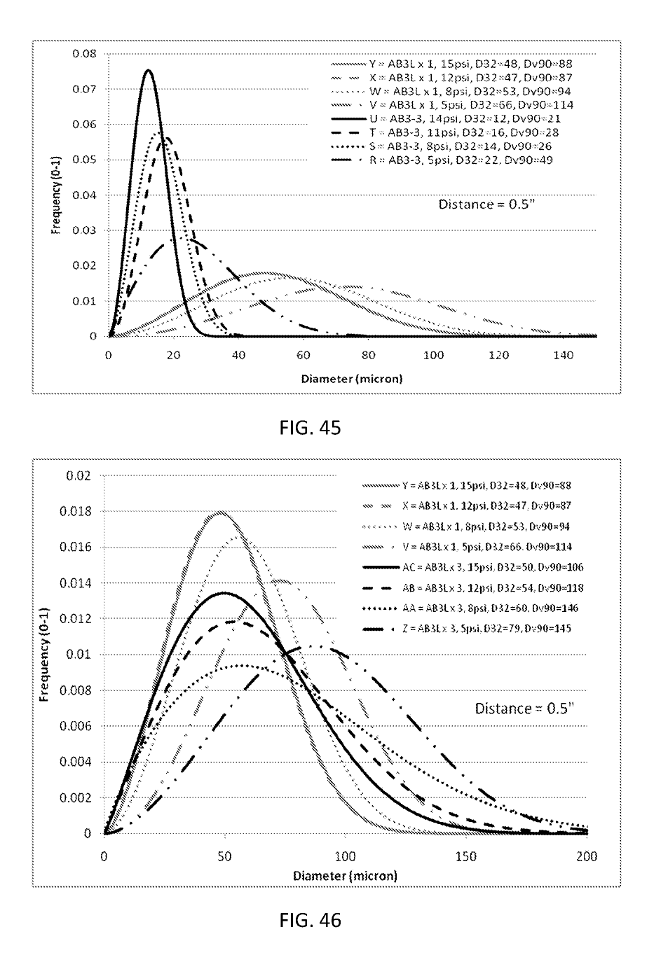

As shown in FIG. 40, Example 7 is similar to Example 4, but with a wider exit and with nozzle placement further from the exit. As shown in FIG. 45, the nozzle array of Example 7 provided significantly larger droplets than the single nozzle design of Example 4. The nozzle array for Example 7 was also arrayed by stacking three plates vertically (12 total nozzles). Accordingly, to compare single and multi-nozzle arrays more directly, FIG. 46 compares the use of one plate versus three plates. Because little difference is illustrated between the single plate and multi-plate systems in FIG. 46, the differences between droplets of Examples 4 and 7 appear to be the result of design differences in the structures rather than recombination after ejection.

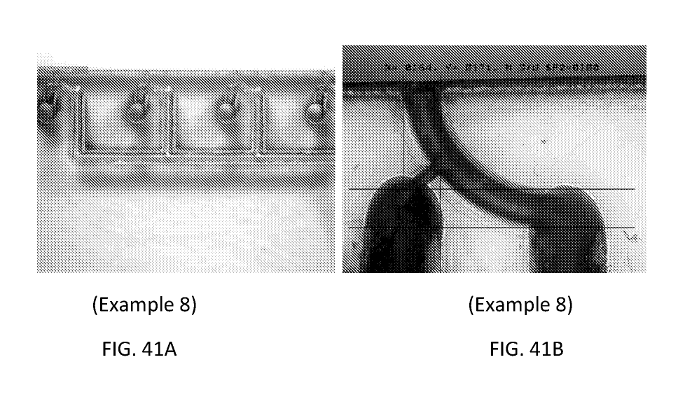

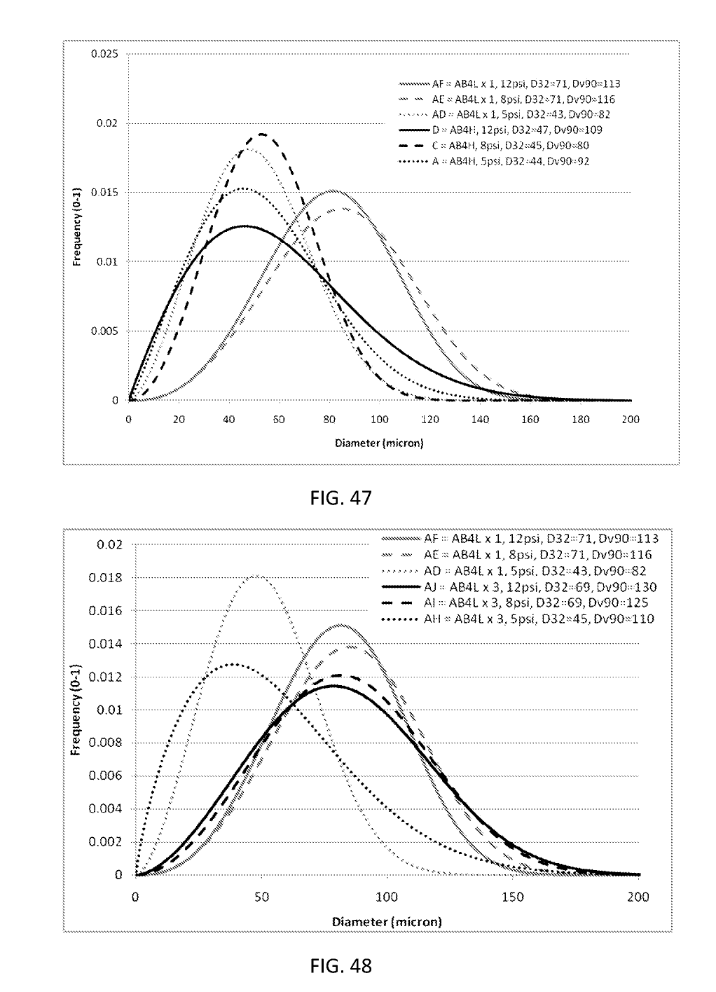

FIG. 41A illustrates an image of the nozzle array of Example 8, and FIG. 41B shows an enlarged view of a portion of one of the exit channels of Example 8. The nozzles of the nozzle array shown in FIG. 41A, but with a shorter and narrower exit and a nozzle positioned substantially closer to the exit. As in the previous example, the array generated larger droplets than the single nozzle. However, as shown in the graph of FIG. 47, the disparity was not as great.

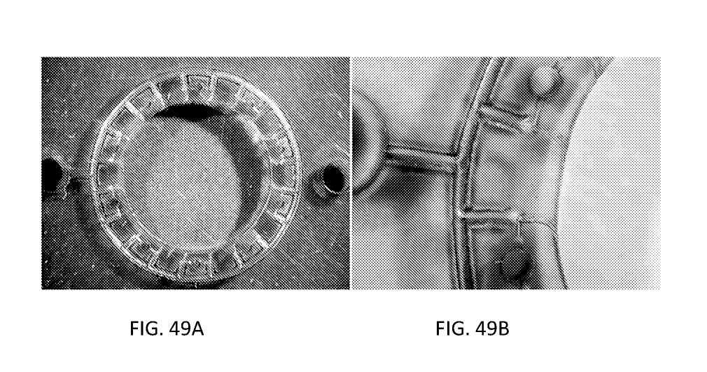

As shown in FIG. 48, a comparison of three plates stacked (12 nozzles) to the single plate (4 nozzles) shows little no significant difference in the drop size. This again leads us to the conclusion that design differences between the single nozzle and the array of nozzles are the source of the of drop size differences.

Accordingly, as discussed above and as shown in the figures, droplet size is generally dependent on exit width and not on nozzle width. In addition, all other things being equal, tangential exits can result in smaller droplets than perpendicular exits.

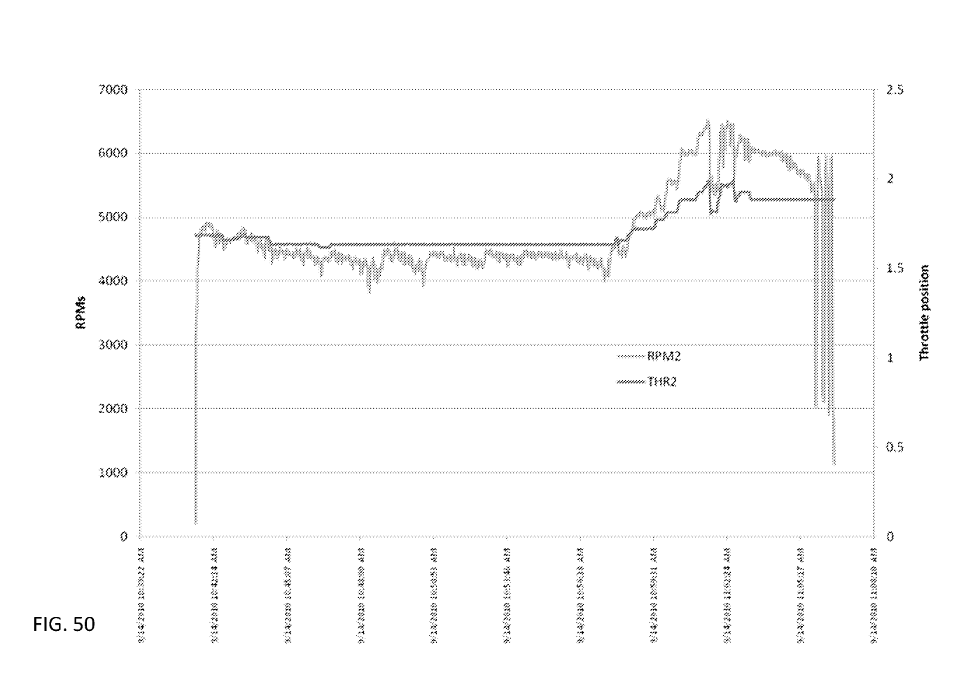

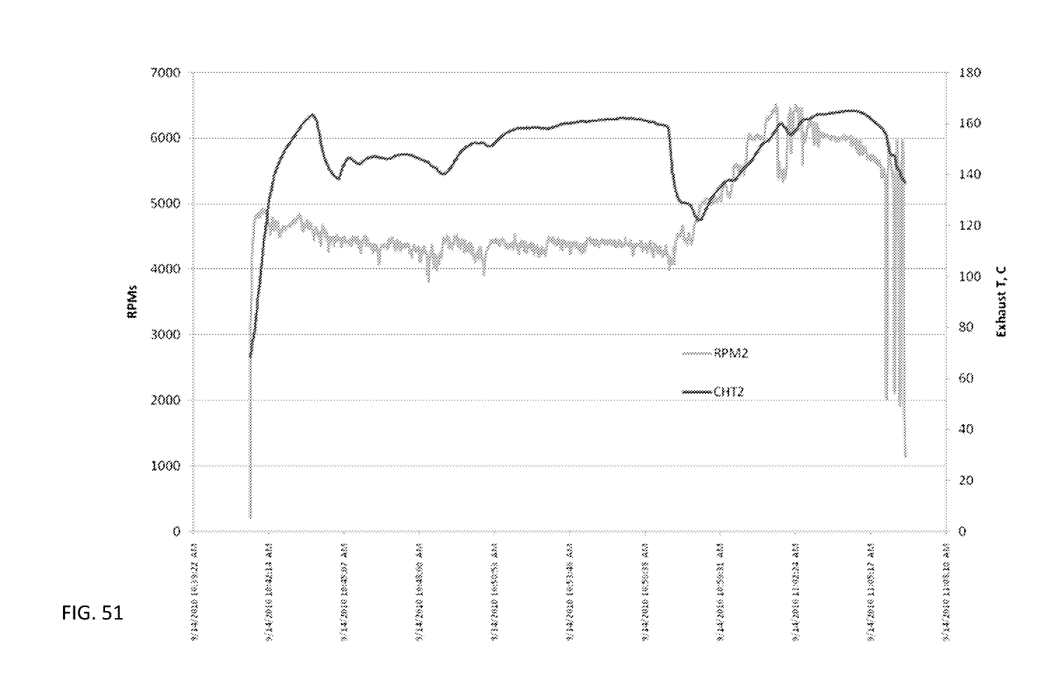

In another embodiment, a device comprising a stack of 4 nozzle plates (9 mmAB5), as shown in FIG. 49A, was provided. FIG. 49B illustrates an enlarged view of the nozzles and exit channels of the device. The device was used to provide an air/fuel mixture sufficient to run a 2 cycle engine continuously for 25 minutes. In this embodiment, each plate was provided with 20 nozzles (80 nozzles total), allowing a low pressure of 5 psi to be used to run the engine steadily between 4200-4400 rpm. After 15 minutes, the rpm were increased and ran at full throttle to test the response across various rpms. FIGS. 50 and 51 are charts that show engine revolutions per minute (RPM), exhaust temperature, and throttle position for a test run of an atomizer constructed as described herein.

In some embodiments, the pressure was increased to 20 psi to deliver adequate fuel for operation at a higher rpm. A decline in fuel efficiency was obvious as the fuel consumption dramatically rose. In some embodiments, fuel delivery through the atomizer can be controlled by modulating by the number of active nozzles rather than forcing more fuel through each.

Fluid Flow Mechanisms for the Various Embodiments

The motive force for ejecting the droplets may be from several sources, and can be a combination of sources. Constant pressure can be used, where droplet formation is through disintegration of the sheet or stream coming out of the nozzle. Pulsed pressure can be used to induce fluctuations in the meniscus in the nozzle bore, thereby creating droplet formation at the nozzle exit. The pulsed force can be induced through the header, addressing all nozzles or groups of nozzles at once, or by incorporating individual nozzle chamber pulsing sources for each nozzle as in conventional inkjet architecture.

Applicable pulsing sources can include piezo, laser, thermal, and electrostatic, among others. A combination of forces can also be used, such as a constant pressure with a mechanical vibration imposed. The vibration can be from an engineered source, such as an ultrasonic force of specified frequency, of simply scavenged from the system, such as coupling engine vibration to the nozzle array. The image of FIG. 23 shows discrete 300 um diameter droplets ejected from a nozzle driven by a piezo pump operating at 300 Hz.

In the air/fuel systems described above, multiple systems can be used to provide the requisite pressure to drive the air and fuel through the atomizer. For example, piezo pumping of fuel can be used to precisely meter fuel through electronic control systems that are analogous to electronic fuel injection. The micronozzles can be grouped into subunits, with each subunit being addressed by separate piezo pumps. The fuel feed rate can be modulated by actuation of the piezo pumps (frequency and amplitude) as well as the number of pumps actuation.

Fuel pressure can also be provided by a diaphragm pump driven by a piston, similar to that achieved in conventional carburetor systems. Venturi forces in the air intake can be used to pull air through the micronozzles. This type of passive operation may be particularly suitable for low cost and/or low performance engines, such as, for example, applications for use with lawnmowers.

Valved Delivery of Fluids

When using low pressure sources for fuel delivery, control of fuel flow can be accomplished by activating the nozzles using valves in a binary fractal channel scheme. The number of nozzles that can be addressed is given by 2ⁿ, where n is the number of valves. For example, just 10 valves can address from 1 to 1024 nozzles, providing 1024 discrete flow rates. The flow rate from individual nozzles can be dependent upon the size and shape, as well as the delivery pressure. If desired, individual nozzle sizes can be vary within a device to match the need of the specific application. In some embodiments, microelectromechanical system (MEMS) valves can be integrated into the laminated design presented here, resulting in a reduced size and cost device. Such MEMS valves can include, for example, magnetic, integrated magnetic inductors, electric, piezoelectric, thermal, bistable, and combinations thereof.

Thermal Desalination Using Micronozzle Arrays

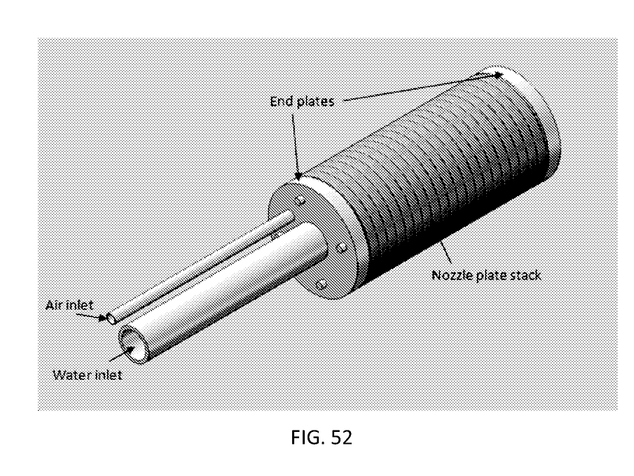

The micronozzle devices disclosed here can be used for atomization as part of thermal seawater desalination. By stacking nozzle, air, and water microchannel plates in sequence, high densities of nozzles can be achieved. For example, a stack of 1500 plates 150 mm in diameter can have 375,000 nozzles, each capable of delivering 2 ml/min of finely atomized water at low pressure (e.g., <20 psi). Such an assembly is shown in FIG. 52. As shown in FIG. 52, a nozzle plate stack can be positioned between end plates and provided in communication with one or more air and water inlets.

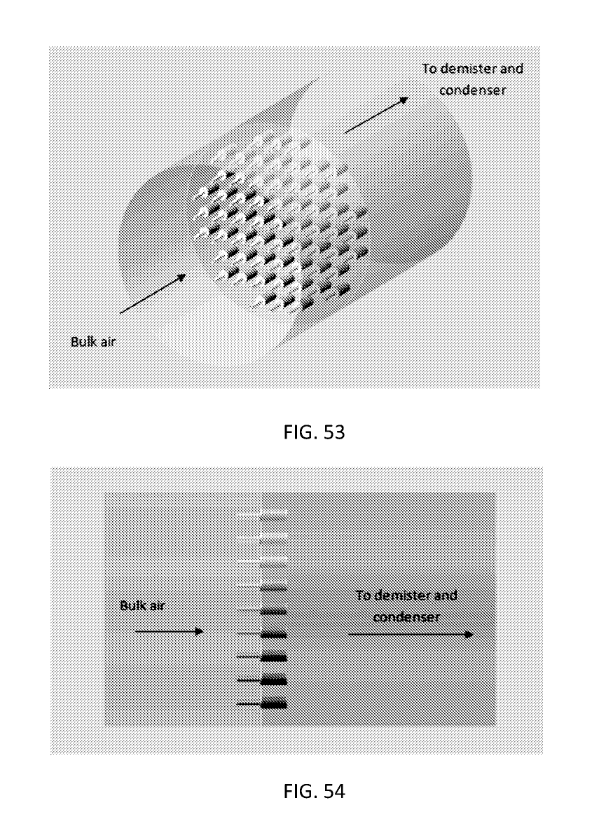

The number of nozzle plates and the number of assemblies can be varied to size the device for the necessary throughput. For example, FIG. 53 illustrates an assembly capable of more than 65,000 cubic meters per day (>17 million gallons per day). As shown in FIG. 53, 61 subassemblies can be provided, with each subassembly being spaced apart about 300 mm on center. In the embodiment shown in FIG. 53, the diameter of the plenum can be about 3 meters.

FIG. 54 further illustrates a partial view of the assembly shown in FIG. 53. As shown in FIG. 54, bulk air can be delivered to the assembly on a first side and then exit the micronozzle arrays on another side for delivery to one or more demisters and condensers.

The nozzle assemblies can be easily disassembly for cleaning and replacement. The minimum feature sizes of the nozzle are 100 micrometers or greater, making them relatively tolerant of particulates.

The micronozzle atomizers described herein can be used to replace electronic fuel injectors in automotive and other related applications. In such cases, pressure for fuel delivery can be provided by a pump and controlled by a regulating valve that returns fuel to the fuel tank. In some cases, a turbocharger can be used to drive air flow in the nozzles.

Thermal control of the device can be accomplished using integrated microchannel heat exchangers, electrical resistance heating, or thermoelectric cooling. Conventional techniques for incorporating these capabilities within the device are known to those skilled in the art. Thermal control may be necessary to heat or cool the fluid to maintain a consistent fluid viscosity, thereby controlling the droplet ejection performance.

Accordingly, as described above, the various micronozzle architectures can be formed in stacked laminae, which can provide a high density of nozzles. The micronozzle architectures can also provide low pressure drops, and can be used with low pressure pulsed droplet ejection mechanisms, such as piezo, thermal, electrostatic, acoustic, and vibrational means. The micronozzle architectures disclosed herein can have utility in a broad number of applications where liquid droplets are ejected into a bulk gas stream, including, but not limited to, fuel injection, spray drying (especially pharmaceutical production), flash evaporation and distillation, evaporation of fuel entering a combustor, and pulmonary drug delivery.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A micronozzle device comprising:
at least two layers stacked together to form a nozzle array, one or more of the layers comprising a plurality of microchannels that have at least one inlet port and a plurality of exit ports, the exit ports being adjacent to a central fluid flow pathway,
wherein the central fluid flow pathway is defined by an annulus of the nozzle array, and the exit ports of the nozzle array face the central fluid flow pathway.

2. The micronozzle device of claim 1, wherein the annulus of the nozzle array form an outer perimeter of the central fluid flow pathway.

3. The micronozzle device of claim 2, further comprising at least one header channel configured to provide fluid to the inlet ports of the plurality of microchannels.

4. The micronozzle device of claim 1, comprising alternating layers of fuel plates and air plates, the fuel plates comprising at least one fuel header channel configured to deliver a fuel to a plurality of vias in the air plate, the air plate comprising at least one air header channel to deliver air to be mixed with the fuel entering the vias of the air plate to form a mixture of air and fuel.

5. The micronozzle device of claim 4, wherein the exit ports are formed on the air plates so that the mixture of air and fuel can exit the micronozzle device through the exit ports.

6. The micronozzle device of claim 5, wherein each layer has a first side and a second side, wherein microchannels are formed on both the first and second sides.

7. The micronozzle device of claim 6, wherein microchannels on adjacent layers are in a staggered arrangement so that microchannels on facing surfaces of adjacent layers do not overlap one another.

8. The micronozzle device of claim 7, wherein the length of each microchannel is less than about 250 μm.

9. The micronozzle device of claim 8, wherein the length of each microchannel is less than about 125 μm.

10. The micronozzle device of claim 1, wherein at least some of the microchannels adjacent the exit ports are curved.

11. The micronozzle device of claim 1, wherein at least some of the exit ports are oriented to direct droplets substantially perpendicularly to an edge of the layer on which the at least some exit ports are located.

12. The micronozzle device of claim 1, wherein at least some of the exit ports are oriented to direct droplets substantially in the direction of an edge of the layer on which the at least some exit ports are located.

13. The micronozzle device of claim 1, wherein the nozzle array is positioned within the central fluid flow pathway, and the exit ports of the nozzle array face the central fluid flow pathway.

14. The micronozzle device of claim 13, wherein the exit ports substantially surround the perimeter of the nozzle array.

15. The micronozzle device of claim 13, wherein the nozzle array further comprises a porous member at an end of the nozzle array.

16. The micronozzle device of claim 13, further comprising a housing that has an inner surface that defines the central fluid flow pathway, wherein at least a portion of the inner surface is covered by a screen member.

17. A micronozzle device comprising:
a plurality of nozzle arrays spaced apart from one another to form a secondary pathway therebetween, each nozzle array comprising a plurality of microchannels that have an inlet port and an exit port, the exit port being oriented substantially parallel to a central fluid flow pathway,
wherein fluid flowing in the central fluid flow pathway can enter the secondary pathways and pass between the plurality of spaced apart nozzle arrays.

18. The micronozzle device of claim 17, wherein each nozzle array comprises a plurality of layers laminated together to form a single structure.

19. The micronozzle device of claim 18, further comprising at least one header channel configured to provide fluid to the inlet ports of the plurality of microchannels.

20. The micronozzle device of claim 19, wherein each layer has a first side and a second side, wherein microchannels are formed on both the first and second sides.

21. The micronozzle device of claim 20, wherein microchannels on adjacent layers are in a staggered arrangement so that microchannels on facing surfaces of adjacent layers do not overlap one another.

22. A micronozzle device comprising:
an air plate having an air inlet, an air header microchannel, a plurality of exit ports, and a plurality of vias, the air plate being configured to receive air through the air inlet and deliver the air through the air header microchannel to the plurality of exit ports;
a fluid plate having a fluid inlet and a fluid header microchannel, the fluid plate being configured to receive fluid through the fluid inlet and deliver the fluid to the air plate through the plurality of vias formed in the air plate,
wherein the air and fluid plates are stacked together to form a nozzle array and the exit ports are oriented to exit into a central fluid flow pathway.

23. The micronozzle device of claim 22, the air plate further comprising metering nozzles positioned between the vias and the exit ports, the metering nozzles being configured to control the flow of fluid delivered to the exit ports.

24. The micronozzle device of claim 22, wherein the nozzle array comprises a plurality of air plates and a plurality of fluid plates that are stacked together in an alternating arrangement.

25. The micronozzle device of claim 24, wherein the central fluid flow pathway is defined by an annulus of the nozzle array, and the exit ports face the central fluid flow pathway.

26. The micronozzle device of claim 25, wherein the annulus of the nozzle array form an outer perimeter of the central fluid flow pathway.

27. The micronozzle device of claim 22, wherein the exit ports are oriented to eject droplets substantially perpendicularly to an edge of the air plate into the central fluid pathway.

28. The micronozzle device of claim 22, wherein the exit ports are oriented to eject droplets substantially in the direction of an edge of the air plate into the central fluid pathway.

29. The micronozzle device of claim 22, wherein the fluid comprises fuel.

30. The micronozzle device of claim 22, wherein the micronozzle device is configured for atomization of seawater and the fluid comprises water.
